(19) United States
(12) Patent Application Publication
(10) Pub. No.: US 2005/0237741 A1
(43) Pub. Date: Oct. 27, 2005

(54) Curtain decorated with light ornaments

(76) Inventor: Chao-Tsung Chang, Taichung (TW)

Correspondence Address: CHARLES E. BAXLEY, ESQ., 90 JOHN STREET, THIRD FLOOR, NEW YORK, NY, 10038, US

(21) Appl. No.: 10/831,665

(22) Filed: Apr. 24, 2004

(51) Int. Cl. F21V 21/00

(52) U.S. Cl. 362/249

(57) ABSTRACT

The present invention relates to a curtain decorated with light ornaments, wherein the base body of the curtain is partially made of light-transmission material and which is interiorly defined with receiving space for the reception of the respective light ornaments. By such arrangements, the lights emitted by the light ornaments can pass through the base body of the curtain and the lights can be changed in color.

### BACKGROUND OF THE INVENTION

1. Field of the Invention

The present invention relates to an improved curtain structure, which is interiorly provided with light ornaments that can generate lights or twinkles, and the lights can be changed in color due to the effect of the color of the curtain.

2. Description of the Prior Arts

Most conventional curtains are use to shield the sunlight, and the curtains are designed with different patterns for home decoration purposes. However, the function of shielding sunlight is useless at night.

Thus, many kinds of curtains appeared in market, with the cooperation of the lights at night, which become one of the shape designs in interior decoration. However, the cost of these curtains is much higher than that of the ordinary curtains, and the lights will occupy a certain spaces.

The present invention has arisen to mitigate and/or obviate the afore-described conventional curtains.

### SUMMARY OF THE INVENTION

The primary object of the present invention is to provide a curtain decorated with light ornaments, wherein the base body of the curtain is partially made of light-transmission material and which is interiorly defined with receiving space for the reception of the respective light ornaments. By such arrangements, the lights emitted by the light ornaments can pass through the base body of the curtain and the lights can be changed in color.

The secondary object of the present invention is to provide a curtain decorated with light ornaments, which can act as a light at night without occupying space.

The curtain decorated with light ornaments in accordance with the present invention includes:
a base body of the curtain made of light-transmission material, which interiorly defined with receiving space;
plural light ornaments received in the receiving space of the base body of the curtain.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is a perspective view of a curtain in accordance with the present invention;

FIG. 2 is a partial perspective view of a curtain in accordance with the present invention;

FIG. 3 is a plan view of a curtain in accordance with the present invention;

FIG. 4 is a cross sectional view of a curtain in accordance with the present invention.

### DETAILED DESCRIPTION OF THE PREFERRED EMBODIMENTS

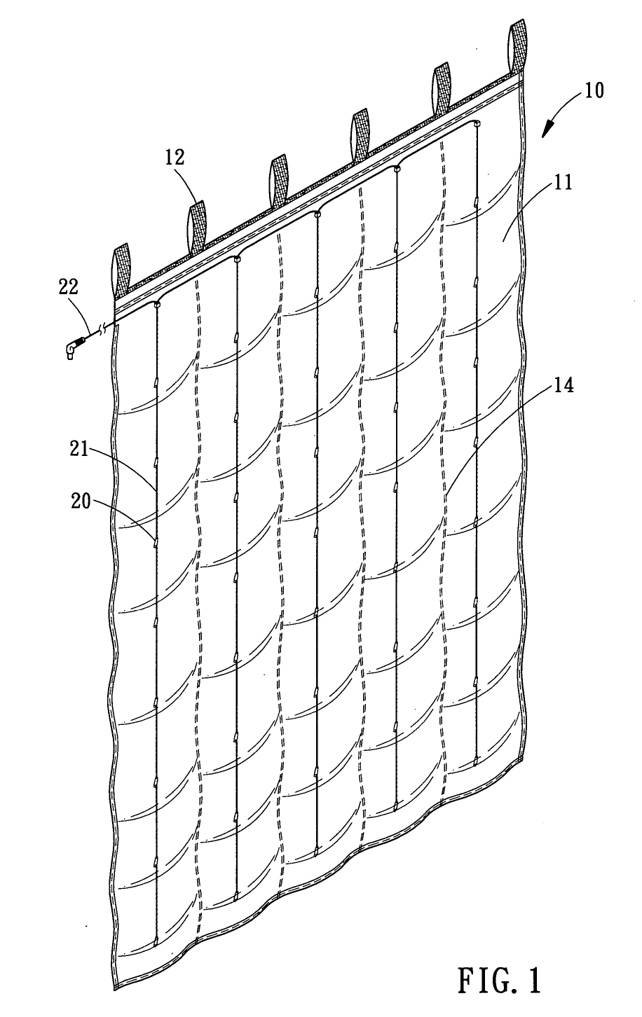

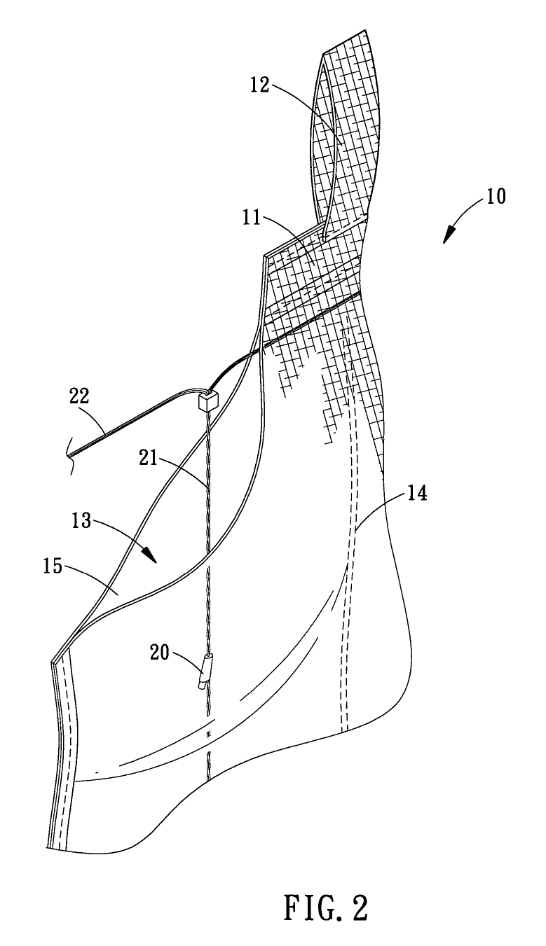

Referring to FIGS. 1 and 2, in accordance with a first embodiment of the present invention there is provided a curtain decorated with lights, a base body 10 is used to be hanged in front of a window with hanging rings 12.

The base body 10 is made of light-transmission material, which is interiorly defined with receiving space 13, and the space 13 are divided into plural small spaces 15.

Plural light ornaments 20 are connected in series to a power cord 22 via wire 21, and the light ornaments 20 are received in the respective small spaces 15 of the receiving space 13 in the base body 10.

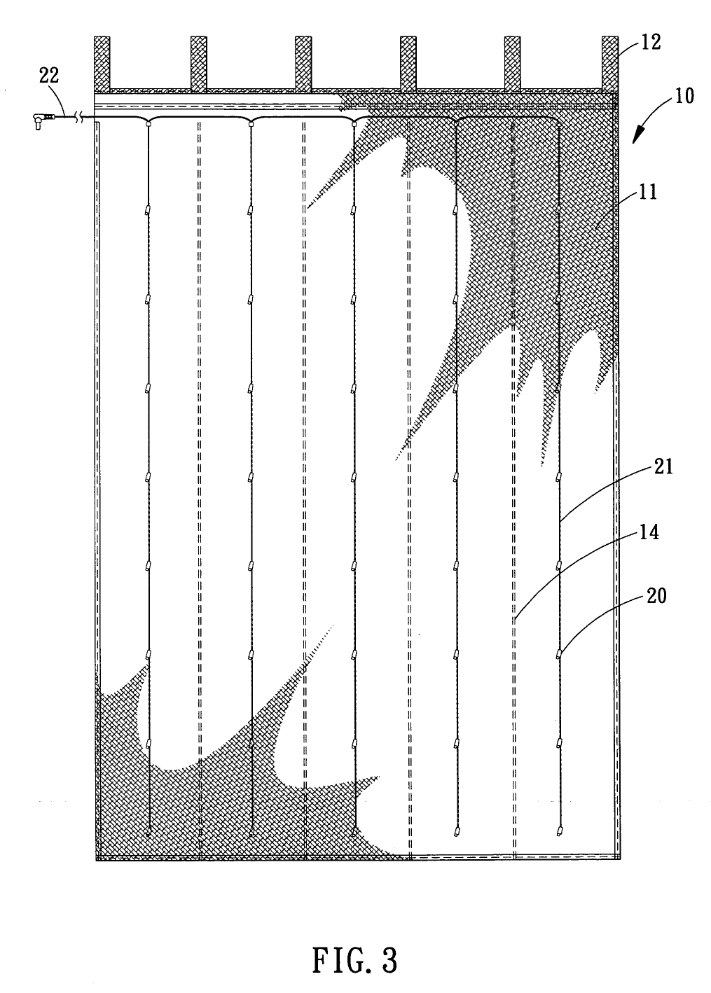

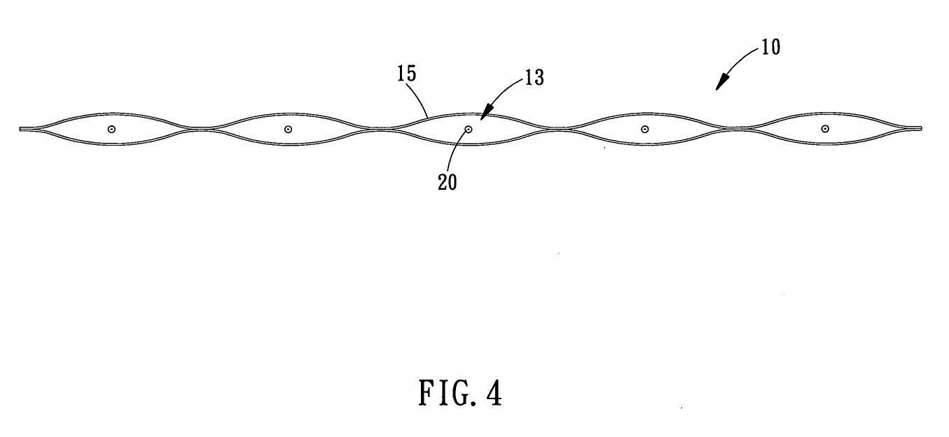

Referring further to FIGS. 3 and 4, since the plural light ornaments 20 are connected in series to the power cord 22 via the wire 21, the respective light ornaments 20 in the respective small spaces 15 of the receiving space 13 of the base body 10 can be switched on and the lights generated by the light ornaments 20 will pass through the light-transmission material 11 of the base body 10, and the lights look like the same color as the base body 10 of the curtain because of the effect of the light-transmission material 11, such that the curtain decorated with light ornaments looks very nice when the lights pass through the base body of the curtain. Thereby the curtain decorated with light ornaments in accordance with the present invention is uniquely structured and has colorful and nice looking since the light ornaments 20 can be in different colors. For example, the receiving space 13 of the base body 10 can be provided with light ornaments 20 of different colors, or a control device can be used to make the light ornaments 20 twinkle so as to create an effect of twinkling.

It will be noted that since the light ornaments 20 generate lights from the respective small spaces 15 of the receiving space 13 of the base body 10, it can act as a light used at night.

While we have shown and described various embodiments in accordance with the present invention, it should be clear to those skilled in the art that further embodiments may be made without departing from the scope of the present invention.

1. A curtain decorated with light ornaments comprising:
a base body of the curtain made of light-transmission material, which interiorly defined with receiving space;
plural light ornaments received in the receiving space of the base body of the curtain.

2. The curtain decorated with light ornaments as claimed in claim 1, wherein the base body of the curtain is partially made of light-transmission material.

3. The curtain decorated with light ornaments as claimed in claim 1, wherein the receiving space is divided into plural small spaces by sewing, and the light ornaments are received in the plural small spaces respectively.

4. The curtain decorated with light ornaments as claimed in claim 1, wherein the respective light ornaments have different color.

5. The curtain decorated with light ornaments as claimed in claim 1, wherein the light ornaments can be controlled to produce twinkling lights.
